(19) United States
(12) Patent Application Publication
(10) Pub. No.: US 2009/0308304 A1
(43) Pub. Date: Dec. 17, 2009

(54) Warning triangle

(76) Inventor: Jung-Yung Ho, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 12/155,884

(22) Filed: Jun. 11, 2008

(51) Int. Cl. G09F 13/16

(52) U.S. Cl. 116/63 T

(57) ABSTRACT

A warning triangle placed on the ground perpendicularly further can be folded over reduced to a minimum volume, comprises three isosceles triangular frame plates (10A, 10B, 10C) connected to one another by an embedded hinge (40) respectively; said embedded hinge (40) includes two opposite sides (41) extended horizontally from two neighbored sides of equal length, said two opposite sides (41) connected by a first pivot axis (42), said two opposite sides (41) are extended downward vertically with two opposite pedestals (43) connected by said first pivot axis (42) to support two consecutive triangle sides standing upright; at least, one of said triangular frame plates (10A, 10B, 10C) is perpendicularly divided into two sub-plates (21, 22) in opposite to each other, and these two sub-plates (21, 22) are connected by a second pivot axis (50).

### FIELD OF THE INVENTION

The present invention is related to a foldable three-dimensional warning triangle; particularly, the warning triangle can be signaled, even on a cross road, to avoid hazards happened to meeting and coming cars.

### BACKGROUND OF THE INVENTION

When there was car breakdown, warning triangle raised at a distance to the car shows a traffic warning sign to cars to slow down and change lanes in view of avoidance from rear-end or head-on collisions; in that, night collisions causing injuries and damages to all parties involved suffered severely are most concerned. It is well known that traffic safety is required for driving cars; at least, a set of warning triangle stands upright to show provisional signals. Warning triangles with retro-reflector or reflector to reduce accidents provided by persons skilled in the art, such as U.S. Pat. No. 6,718,670 entitled “triangle warning sign” to Wencai Wang on Apr. 13, 2004 (hereinafter Wang); or U.S. Pat. No. 4,230,063 entitled “inflatable automobile warning reflector” to Conlly Chang on Oct. 28, 1980 (hereinafter Chang). Wang provided inner and outer equilateral triangle adorned with reflector and retro-reflector respectively; when folded, there are “two lateral components of said triangular frame can be foldably rotated with the two fasteners at two ends of a bottom edge as rotating centers respectively” and “one counterweighed supporting plate and four supporting legs must be added to the bottom edge . . . a supporting leg fixed seat has four semicircular grooves used to engage and secure said four supporting legs”. Furthermore, set up the warning triangle of Wang, which is conditioned by such as “resilient hook of each flat positioning insert pins inserted in the insert holes of the supporting plate”.

Chang provided an inflatable triangular reflector with two L shaped supports behind the reflector; either a belt hook is used to fix said triangle on a trunk of a car, or the triangle weighted with a heavy material when considering stability against wind.

A common sense of the erected warning triangle may be allowed inclined at an angle, which is limited up to 5 degrees to facilitate warning triangle positioned at driver level for high-visibility. But warning triangle almost perpendicularly erected on ground are easily blown away or fallen down by passing cars.

How to set up a warning triangle visible, portable, foldable but capable of stably standing upright on the ground is sought by users.

### SUMMARY OF THE INVENTION

Accordingly, the present invention is to provide a warning triangle placed perpendicularly, further can be folded to a small size.

To solve problems as mentioned above, a warning triangle comprises three isosceles triangular frame plates (10A, 10B, 10C) characterized in that: the three frame plates (10A, 10B, 10C) are connected to one another by an embedded hinge (40) respectively on three vertices met by each two neighbored sides of three consecutive isosceles triangular framed plates; said embedded hinge (40) includes two opposite sides (41) extended horizontally from two consecutive isosceles triangular frame plates sides of equal length, said two opposite sides (41) connected by a first pivot axis (42); at least, one of said triangular frame plates (10A, 10B, 10C) is perpendicularly divided into two sub-plates (21, 22) in opposite to each other, and these two sub-plates (21, 22) are connected by a second pivot axis (50).

The warning triangle of claim 1 wherein said two opposite sides (41) are extended downward vertically with two opposite pedestals (43) connected by said first pivot axis (42) to support the vertex met by two consecutive triangle sides standing upright.

The warning triangle of claim 1 wherein said first pivot axis (42) is integrally formed with said two opposite sides (41) as a whole slice sheet to be foldable and made of analogous stiffeners for flexible folding.

The warning triangle of claim 1 wherein said first pivot axis (42) is a flexible tape (44) connected between said two opposite sides (41).

The warning triangle of claim 1 wherein said flexible tape (44) is selected from one of the following: adhesive tape, adhesive plaster, or elastic band.

The warning triangle of claim 1 wherein said first pivot axis (42) is a hinge (45) connected between said two opposite sides (41).

The warning triangle of claim 1 wherein said second pivot axis (50) is integrally formed with said two opposite sub-plates (21, 22) as a whole made of analogous material to be foldable as a slice sheet (51).

The warning triangle of claim 1 wherein said second pivot axis (50) is a flexible tape (52) connected between said two opposite sub-plates (21, 22).

The warning triangle of claim 1 wherein said flexible tape (52) is selected from one of the following: adhesive tape, adhesive plaster, or elastic band.

The warning triangle of claim 1 wherein said second pivot axis (50) is a hinge (53) connected between said two opposite sub-plates (21, 22).

The warning triangle of claim 1 wherein front faces of said frame plates (10A, 10B, 10C) adorned with reflectors (30) respectively; at least, one of said reflectors (30) is perpendicularly divided into two opposite right-angled triangular sub-reflectors (31, 32); front faces of said two sub-plates (21, 22) are adorned with said two sub-reflectors (31, 32) respectively.

The warning triangle of claim 1 wherein widths of said reflectors (30) are smaller than said frame plates (10A, 10B, 10C); which are adorned with said reflectors (30) on an outer isosceles triangle.

### ADVANTAGES OF EMBODIMENTS OF THE INVENTION

Said warning triangle (1) of the present invention, in practice, can achieve advantages as following:

Said frame plates (10A, 10B, 10C) are connected one another by three embedded hinges (40) respectively; each pair of opposite sub-plates (21, 22) are connected each other by said second pivot axis (50). Thereby, said warning triangle (1) is collapsible through either embedded hinges (40) or second pivot axis (50) or both. Said warning triangle (1) spreads up in full size or to be folded in small size rapidly, that is easy to use and easy to collect.

Said embedded hinge (40) includes two opposite sides (41) extended horizontally from two neighbored sides, said two opposite sides (41) connected by a first pivot axis (42); said sides (41) capable of stably upright standing said frame plates (10A, 10B, 10C) without any inclinations. Incident light of coming cars directly cast to the warning triangle readily positioned at driver level with high-visibility.

Three pairs of opposite sides (41) are extended downward vertically with three pairs of opposite pedestals (43) connected by said first pivot axis (42) to support six consecutive triangle sides stably standing upright.

Sub-plates (21, 22) of each said frame plates (10A, 10B, 10C) adorned with separate sub-reflectors (31, 32) respectively, coming cars approached said warning triangles (1), which bounced back incident light of head lights warning coming cars to slow down and change lanes.

### BRIEF DESCRIPTION OF DRAWINGS

FIG. 1: is a perspective view of the warning triangle of the first embodiment of the present invention;

FIG. 2: is an exploded view of the frame plate in part of FIG. 1;

FIGS. 3A˜3C: are schematic views of said sides folded in or away along III-III of FIG. 2;

FIGS. 4A-4C: are schematic views of opposite sub-plates folded in or away along IV-IV of FIG. 1;

FIG. 5: is a perspective view of the warning triangle of the second embodiment of the present invention;

FIG. 6: is a perspective view of the warning triangle of the third embodiment of the present invention;

FIG. 7: is a perspective view of the warning triangle folded to a minimum;

FIG. 8: is a perspective view of the warning triangle of the second embodiment of the present invention; and

FIG. 9: is a perspective view of the warning triangle of FIG. 8 folded to a minimum.

### DETAILED DESCRIPTION OF THE PREFERRED EMBODIMENTS OF THE PRESENT INVENTION

Description is described in detail according to the appended drawings hereinafter.

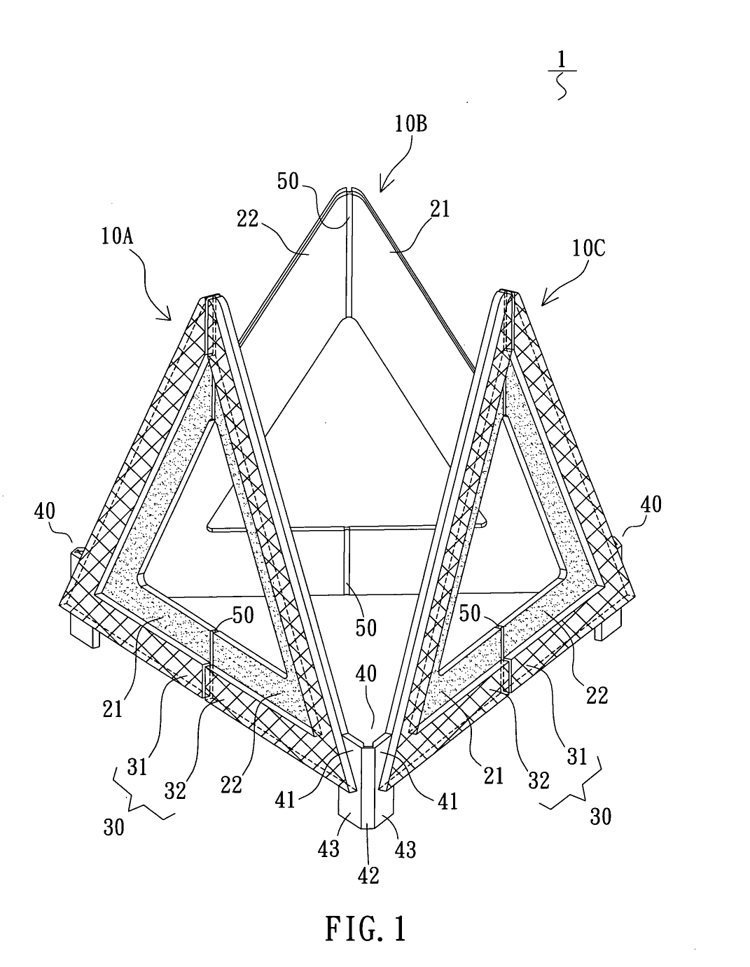

As shown in FIG. 1, a perspective view of a warning triangle of a first embodiment is illustrated. Such a warning triangle of the present invention can be embodied by a plurality of consecutive frame plates. In the present invention, it is preferably exemplified by three isosceles triangular frame plates (10A, 10B, 10C).

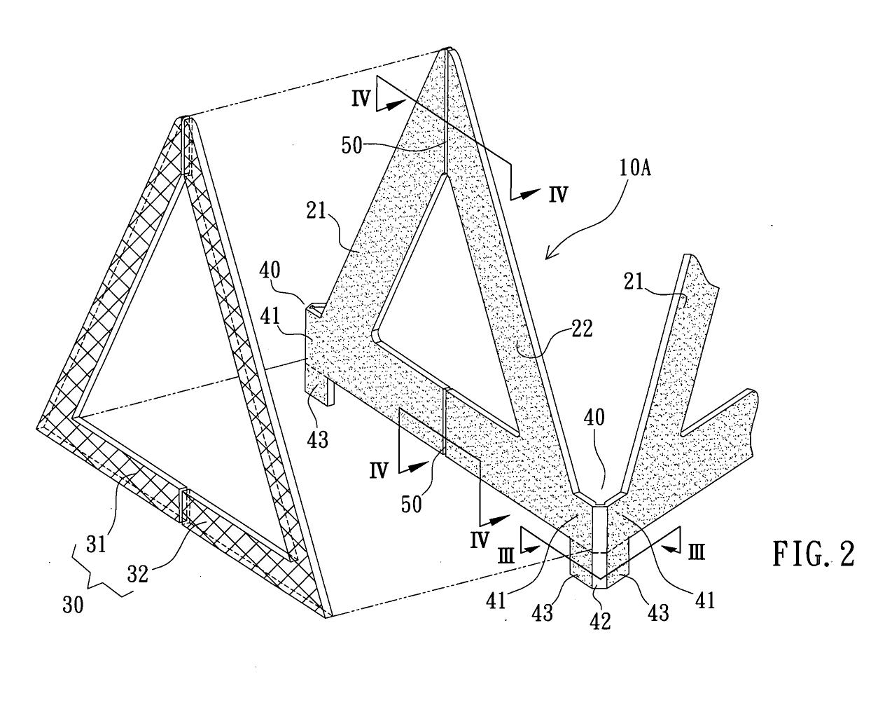

As shown in FIG. 2, an exploded view of a frame plate of FIG. 1 is illustrated. the three frame plates (10A, 10B, 10C) are connected to one another by an embedded hinge (40) respectively on a vertex met by two neighbored sides of two consecutive isosceles triangular framed plates; said embedded hinge (40) includes two opposite sides (41) extended horizontally from two neighbored sides, said two opposite sides (41) connected by a first pivot axis (42).

Said two opposite sides (41) are extended downward vertically with two opposite pedestals (43) also connected by said first pivot axis (42) to support two consecutive triangle sides standing upright. As a result, said frame plates (10A, 10B, 10C) are hoisted from the ground and rests on the pedestals (43) evenly.

Each of said triangular frame plates (10A, 10B, 10C) is perpendicularly divided into two sub-plates (21, 22) in opposite to each other, and these two sub-plates (21, 22) are connected by a second pivot axis (50). In other words, the second pivot axis (50) acts as a central pivot rotatably connected between two sub-plates (21, 22).

Each pair of said sub-plates (21, 22) are frame-shaped and opposite to each other. When said opposite sub-plates (21, 22) spread out to form an isosceles triangle with a hollowed-out triangular hole. Both top and bottom ends of said two opposite sub-plates (21, 22) are connected and hinged by a second pivot axis (50) respectively. Those two second pivot axes (50) are opposite to each other and distributed in symmetry.

Said frame plates (10A, 10B, 10C) made of plastics, such as polystyrene (PS), polycarbonate (PC) etc., mixed with Day-Glo fluorescent pigments, such as an opaque orangish red pigment. The sub-plates (21, 22) are therefore designed with fluorescent warning sign. Next, front faces of said frame plates (10A, 10B, 10C) adorned with reflectors (30) respectively match corresponding shape in fluorescent pigments. Said reflectors (30) are made of acrylic, widths of said reflectors (30) are smaller than each of said frame plates (10A, 10B, 10C).

After said frame plates put on said reflectors (30) on said front faces, it is clearly seen that said frame plates (10A, 10B, 10C) are adorned with said reflectors (30) on an outer isosceles triangle. An inner isosceles triangle of the frame plates, serves as contrast, is easy to see in fluorescent orange. When coming cars cast light over the front face of the frame plate, said reflector (30) bounces back light in red, while “chain reaction” of the frame plate is, change according to a changing circumstance, reacted with fluorescent warning sign in orange. Also, said front face of the frame plate can be dotted with convex dots or concave dents to refract incident lights to alert coming cars best kept at safe distances.

Due to said frame plates (10A, 10B, 10C) are all composed of a pair of opposite sub-plates (21, 22) respectively; therefore, each of said reflector (30) should be divided into two separate sub-reflectors (31, 32) corresponding to said sub-plates (21, 22) respectively. But those two sub-reflectors (31, 32) are separated from each other, no such pivot axis connected in between.

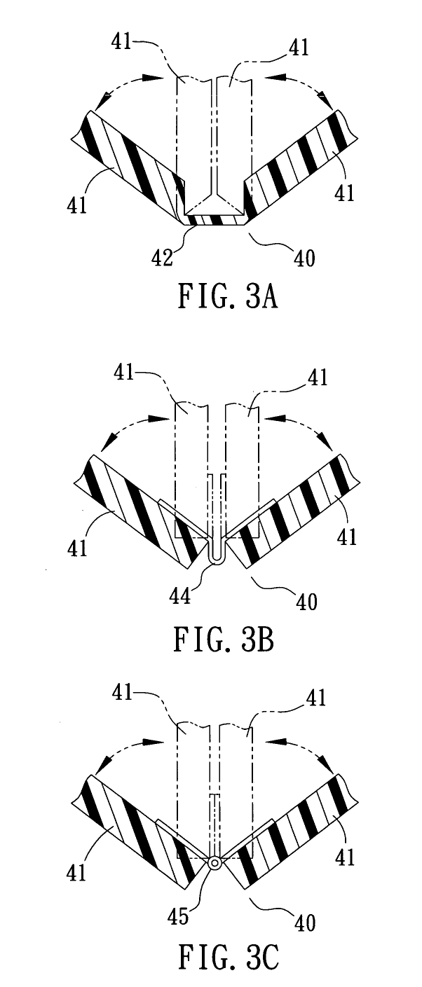

As shown in FIGS. 3A˜3C, schematic views along III-III of said embedded hinge (40) of FIG. 2 are illustrated. In FIG. 3A, said embedded hinge (40) is substantially composed of said two opposite sides (41) and connected by said first pivot axis (42). Said sides (41) and said first pivot axis (42) are made of analogous stiffeners and formed integrally as a whole slice sheet for flexible folding. In FIG. 3B, said pivot axis (42) connected between said opposite sides (41) is substantially shaped as a flexible tape (44), which is selected from one of the following: adhesive tape, adhesive plaster, or elastic band. Next, as shown in FIG. 3C, said pivot axis (42) connected between said opposite sides (41) is a hinge (45). As above, said hinge, flexible tape, and slice sheet can be used as said pivot axis (42) combined with said sides (41) to form said embedded hinge (40) connected between two consecutive said frame plates.

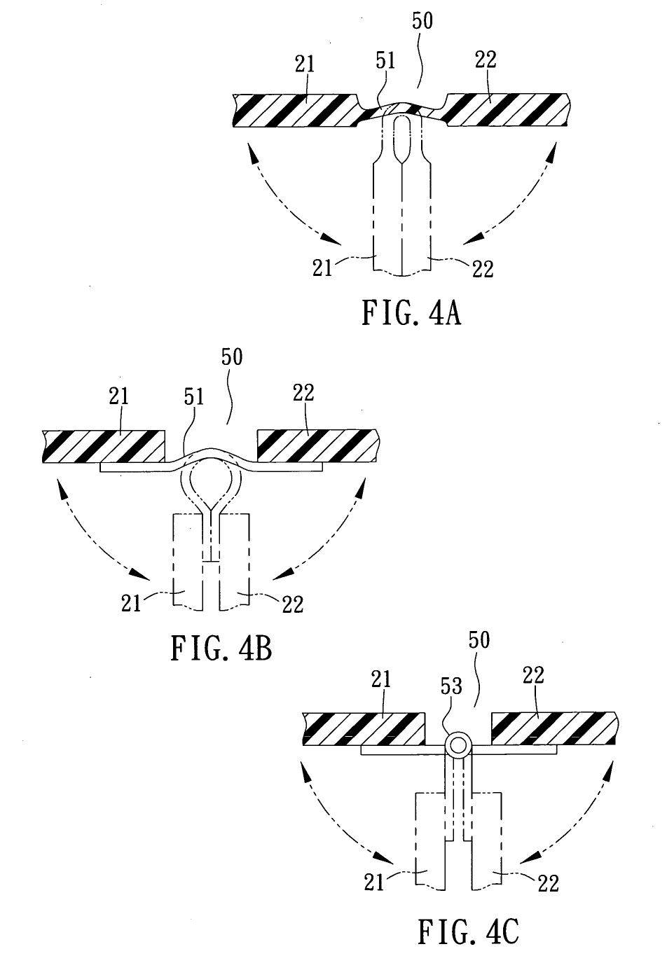

As shown in FIGS. 4A˜4C, sectional views along IV-IV of said pivot axis (50) are illustrated. In FIG. 4A, said pivot axis (50) is integrally formed with said sub-plates (21, 22) as a whole slice sheet (51) made of analogous stiffeners for flexible folding. In FIG. 4B, said pivot axis (50) connected between said opposite sub-plates (21, 22) is substantially shaped as a flexible tape (52), which can be selected from the following: adhesive tape, adhesive plaster, or elastic band. In FIG. 4C, said pivot axis (50) connected between said sub-plates (21, 22) is a hinge (53). As above, said hinge, flexible tape, and slice sheet can be used as said pivot axis (50) connected between two opposite said sub-plates.

Stably upright standing of said warning triangle of the present invention can be further performed by three embodiments as following:

### First Embodiment

As shown in FIG. 1, a first embodiment of the invention is illustrated. Frame plates (10A, 10B, 10C) are stably upright standing perpendicular to the ground at a right angle (90°), three consecutive said frame plates spread up and are connected to one another and support one another on an overall round three cornered triangular ground with each warning triangle facing outward almost perpendicular to the ground. Thus, said overall round three cornered triangle with three vertices met by three straight three warning triangles consecutively connected to one another, each of which is stably upright standing with an individual apex, is suitable placed on a cross road as a high-visibility warning triangle.

### Second Embodiment

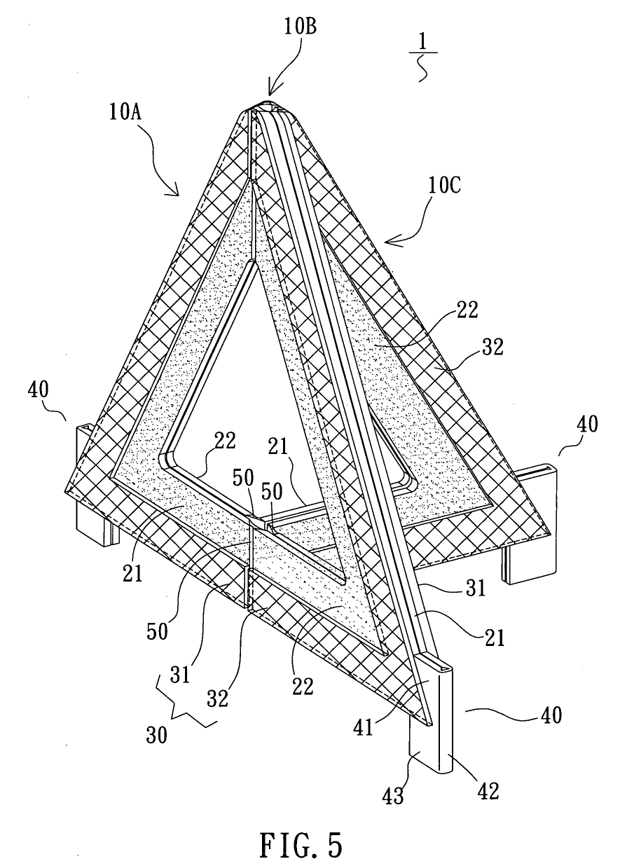

As shown in FIG. 5, said frame plates (10A, 10B, 10C) are stably upright standing perpendicular to the ground at a right angle (90°), one of said frame plate (10A) spreads up; but other frame plates (10B, 10C) are folded in at a right angle; thus each pair of sub-plates (21, 22) are folded over each other to form double layer sub-plates. Meanwhile, the warning triangle is substantially placed on the ground shaped in an overall T shape with three arms are all enhanced by double layer sub-plates.

### Third Embodiment

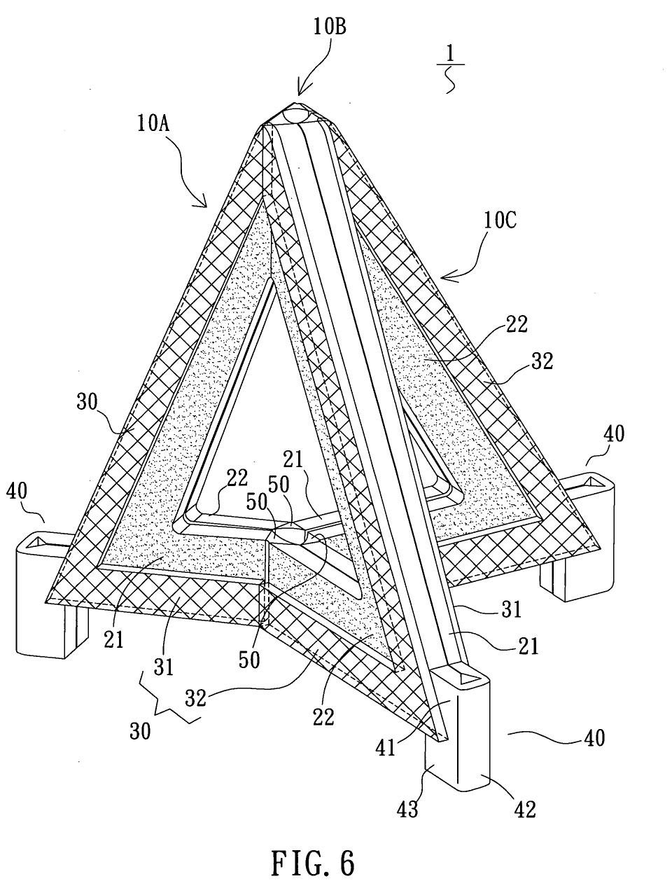

As shown in FIG. 6, said frame plates (10A, 10B, 10C) are stably upright standing perpendicular to the ground at a right angle (90°), all of the frame plates (10A, 10B, 10C) are folded in at a right angle; thus each pair of sub-plates (21, 22) are folded over each other to form double layer sub-plates. Meanwhile, the warning triangle is substantially placed on the ground with three folded-in double layer sub-plates with bases being stably stretched out evenly as a trifurcate holder, and included angles of each two neighbored sub-plates are 120° with stability against wind.

Also, when the warning triangle is folded to be received, there are two embodiments in practice as following:

### First Embodiment

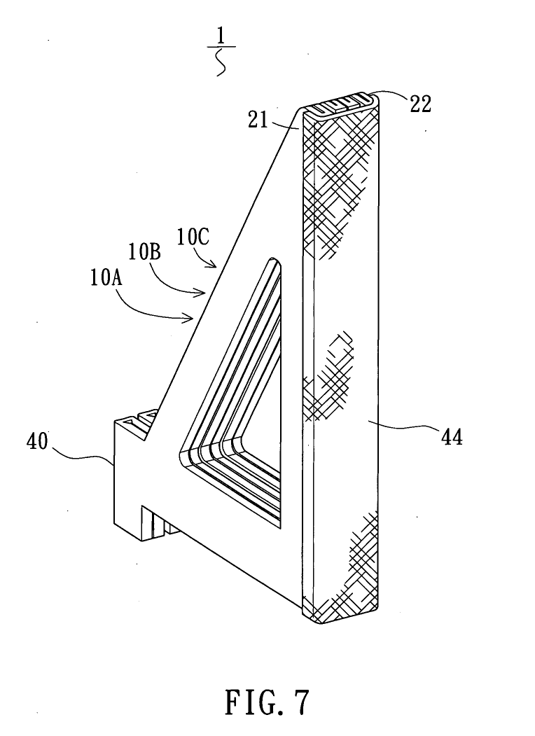

As shown in FIG. 7, the warning triangle of the first embodiment folded to a minimum volume is illustrated. When the warning triangle is to be received, each of said three consecutive frame plates (10A, 10B, 10C) are folded in at right angle in a neat stack shaped as multi layer right-angle triangle to be received in the trunk of a car. When received, the frame plate (10A) is folded to an uppermost layer of the multi layer right-angle triangle. And when the frame plate (10A) is folded, said embedded hinge (40) must be extended to a most extensible extent for a flexible folding with said two sub-plates (21, 22) folded over to each other. Therefore, the flexible tape (44) is suitably adopted as the embedded hinge (40) of the frame plate (10A) to facilitate folding in the frame plate (10A).

### Second Embodiment

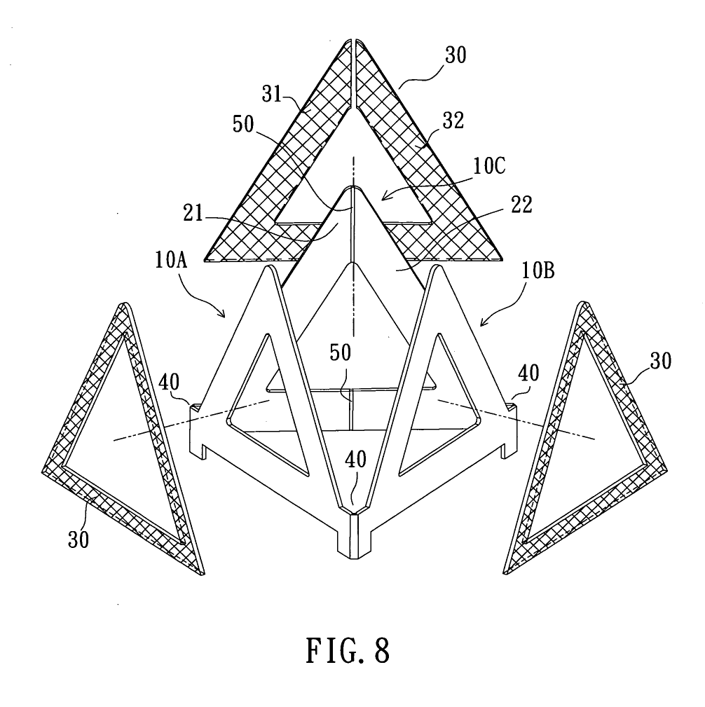

As shown in FIG. 8, said frame plates (10A, 10B) are not designed with foldable sub-plates, only said frame plate (10C) is divided into a pair of sub-plates (21, 22), which are both right-angle triangle opposite to each other. Correspondingly, only said frame plate (10C) adorned with said reflector (30) is divided into two sub-reflectors (31, 32) in opposite to each other. While said reflectors (30) on the frame plates (10A, 10B) are not necessarily divided into two sub-reflectors.

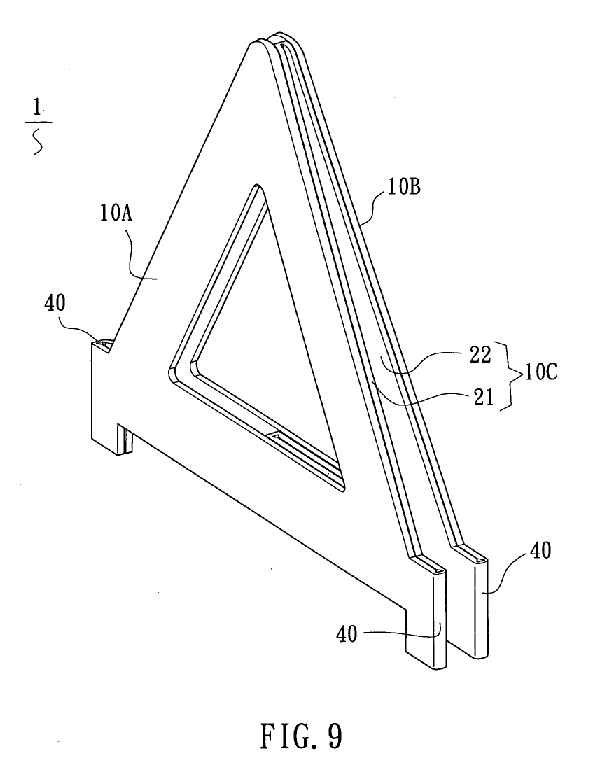

As shown in FIG. 9, the warning triangle of FIG. 8 is folded to a minimum volume. Said two frame plates (10A, 10B) are folded over to each other, but said frame plate (10C) sandwiched between said two frame plates (10A, 10B) is folded in by two foldable sub-plates (21, 22) fold over to each other.

What is claim claimed:

1. A warning triangle comprises three isosceles triangular frame plates (10A, 10B, 10C) characterized in that: the three frame plates (10A, 10B, 10C) are connected to one another by an embedded hinge (40) respectively on three vertices met by each two neighbored sides of three consecutive isosceles triangular framed plates; said embedded hinge (40) includes two opposite sides (41) extended horizontally from two consecutive isosceles triangular frame plates sides of equal length, said two opposite sides (41) connected by a first pivot axis (42); at least, one of said triangular frame plates (10A, 10B, 10C) is perpendicularly divided into two sub-plates (21, 22) in opposite to each other, and these two sub-plates (21, 22) are connected by a second pivot axis (50).

2. The warning triangle of claim 1 wherein said first pivot axis (42) is integrally formed with said two opposite sides (41) as a whole slice sheet to be foldable and made of analogous stiffeners for flexible folding.

3. The warning triangle of claim 1 wherein said first pivot axis (42) is a flexible tape (44) connected between said two opposite sides (41).

4. The warning triangle of claim 1 wherein said first pivot axis (42) is a hinge (45) connected between said two opposite sides (41).

5. The warning triangle of claim 1 wherein said second pivot axis (50) is integrally formed with said two opposite sub-plates (21, 22) as a whole made of analogous material to be foldable as a slice sheet (51) for flexible folding.

6. The warning triangle of claim 1 wherein said second pivot axis (50) is a flexible tape (52) connected between said two opposite sub-plates (21, 22).

7. The warning triangle of claim 1 wherein said second pivot axis (50) is a hinge (53) connected between said two opposite sub-plates (21, 22).

8. The warning triangle of claim 1 wherein front faces of said frame plates (10A, 10B, 10C) adorned with reflectors (30) respectively; at least, one of said reflectors (30) is perpendicularly divided into two opposite right-angled triangular sub-reflectors (31, 32); front faces of said two sub-plates (21, 22) are adorned with said two sub-reflectors (31, 32) respectively.
